(19) United States
(12) Patent Application Publication
(10) Pub. No.: US 2018/0170657 A1
(43) Pub. Date: Jun. 21, 2018

(54) CONTAINER HAVING A PLURALITY OF CUT EDGES

(71) Applicant: PHILIP MORRIS PRODUCTS S.A., Neuchatel (CH)

(72) Inventors: David Rudolf, Kutna Hora (CZ); Poh Yoke Tritz, Yverdon-les-Baines (CH)

(21) Appl. No.: 15/577,409

(22) PCT Filed: Jun. 21, 2016
(86) PCT No.: PCT/EP2016/064261

§ 371 Date: Nov. 28, 2017

(30) Foreign Application Priority Data
Jun. 22, 2015 (EP) 15173181.7

(51) Int. Cl. B65D 85/10; B65D 5/00; A24F 15/12; B23K 26/38; B31B 50/16

(52) U.S. Cl. CPC B65D 85/10; B65D 85/1036; B65D 5/00; B23K 2203/40; B23K 26/38; B31B 50/16; A24F 15/12

(57) ABSTRACT

A container for consumer articles is at least partially formed from a blank having a thickness (T), a first surface and a second surface, wherein at least a portion of the blank is delimited by a plurality of cut edges that extend from the first surface of the blank to the second surface of the blank. At least one of the cut edges has a cut edge surface that extends along a plane (A) forming a non null angle (θ) with a plane (O) that is orthogonal to the inner surface and the outer surface of the blank portion, the first and the second plane (A, O) belonging to a same sheaf of planes, wherein the axis of the sheaf of planes extends along the plane defined by the first surface of the blank, such that, at the at least one cut edge, the second surface of the blank portion extends beyond the periphery of the first surface of the blank portion.

The present invention relates to containers having cut edges, and for holding consumer goods, such as smoking articles (for example cigarettes). The invention also relates to blanks, especially laminar blanks, for forming such containers, and to a method for forming such blanks and containers.

Smoking articles such as cigarettes and cigars are usually provided in soft-pack packs or hard-pack packs, such as flip-top boxes or hinge-lid boxes. These typically have a box part having a box front wall, a box rear wall, box side walls and a box base. They also usually have a lid part with a lid front wall, a lid rear wall, lid side walls and a lid top side. The lid part is typically hinged to the box part along a hinge line extending across a back wall of the container. The hinge line is usually provided as a pre-folded line, a crease line or a score line.

Hard-pack containers, or at least portions thereof, are typically obtained from a laminar blank comprising a plurality of panels. In order to assemble a container, one such blank is folded so that panels of the blank can form walls of the containers. It is also known to provide such containers with cut out portions.

In known methods, blanks are cut with mechanical blades. However, this limits the flexibility and versatility of the manufacturing method, in that it is difficult to adapt existing apparatus to cut blanks for forming containers with novel, distinctive designs. This applies both to edges defining the periphery of a blank panel for forming a wall of a container as well as to edges of cut out portions provided in an internal position in a blank panel.

It would therefore be desirable to provide a container for consumer goods that has an improved look. Further, it would be desirable to provide a method and blank for manufacturing one such container for consumer goods, which do not require any major modification of existing packing apparatus.

According to an aspect of the present invention, there is provided a container for consumer articles, the container being at least partially formed from a blank having a thickness (T), a first surface and a second surface. At least a planar portion of the blank is delimited by a plurality of cut edges that extend from the first surface of the blank to the second surface of the blank. At least one of the cut edges has a cut edge surface that extends along a plane (A) forming a non null angle (θ) with a plane (O) that is orthogonal to the inner surface and the outer surface of the blank portion, the first and the second plane (A, O) belonging to a same sheaf of planes, wherein the axis of the sheaf of planes extends along the plane defined by the first surface of the blank, such that, at the at least one cut edge, the outer surface of the blank portion extends beyond the periphery of the inner surface of the blank portion.

According to another aspect of the present invention, there is provided a blank for forming a container for consumer articles, the blank having a thickness (T) and at least a planar portion of the blank delimited by a plurality of cut edges, wherein the blank portion has a first surface and a second surface. At least one of the cut edges in the plurality of cut edges has a cut edge surface that lies in a plane (A) forming a non null angle (θ) with a plane (O) that is orthogonal to the first surface and the second surface of the blank portion, the first and the second plane (A, O) belonging to a same sheaf of planes, wherein the axis of the sheaf of planes extends along the plane defined by the first surface of the blank, such that, at the at least one cut edge, the outer surface of the blank portion extends beyond the periphery of the inner surface of the blank portion.

According to a further aspect of the present invention, there is provided a method of cutting a blank for the manufacture of a container for consumer articles, the blank having a first surface and a second surface. The method comprises forming a cut edge of a planar portion of the blank by cutting through the blank with a laser beam directed against the first surface of the blank along a direction (D) forming a non null angle (θ) with a direction (O) orthogonal to the first surface and the second surface of the blank portion, the first and the second plane (A, O) belonging to a same sheaf of planes, wherein the axis of the sheaf of planes extends along the plane defined by the first surface of the blank, such that at the cut edge the outer surface of the blank portion extends beyond the periphery of the inner surface of the blank portion.

It shall be appreciated that any features described with reference to one aspect of the present invention are equally applicable to any other aspect of the invention.

In contrast to known methods, according to the present invention a laser beam is used to cut through a blank along a direction that forms a non-null angle with a direction perpendicular to the plane of the blank. Thus, at the cut edge, one surface of the blank extends beyond the other surface of the blank.

Accordingly, it is easy to form a container with edges of various, possibly also complicated geometries. The increased versatility provided by the use of a laser beam as a cutting tool is advantageously coupled with a distinctive and possibly improved look of the container.

Further, in some embodiments, when the blank is bent into shape, the cut edge surface of the edge may be arranged such as to face at least partially away from the consumer's gaze. Accordingly, any potential aesthetic flaw is substantially not exposed to the consumer.

In other embodiments, when the blank is bent into shape, the cut edge surface of the edge may be arranged such as to be exposed almost entirely to the consumer's gaze. Accordingly, a container with a novel, distinctive look may be provided to the consumer.

The second surface of the blank is substantially unaffected by the laser cutting operation, and so the resulting second surface of the container is smooth upon visual and tactile inspection on the part of the consumer. In addition, manufacturing the blank or container is easy and only requires a minor modification of the existing apparatus. This is to ensure that the laser beam is directed at an angle greater than zero and less than 90 degrees with respect to the plane of the inner surface of the blank during the cutting operation.

As used herein, the terms “front”, “back”, “upper”, “lower”, “top”, “bottom” and “side”, refer to the relative positions of portions of containers according to the invention and components thereof when the container is in an upright position with the lid of the outer housing in the closed position and the hinge line at the back of the container. When describing containers according to the present invention, these terms are used irrespective of the orientation of the container being described. In the case of a hinge lid container, the back wall is the wall comprising the hinge line.

The term “inner surface” is used throughout the specification to refer to the side of a portion of the blank that, once the container is assembled, faces towards the interior of the container. The “inner surface” faces, for example, towards the consumer goods, when the container is closed. Thus, the inner surface is not directly visible for the consumer when the container is closed. The term “outer surface” is used throughout the specification to refer to the side of a portion of the blank that, once the container is assembled, faces away from the container.

The term “curved” is used in the present specification to describe any non-straight line, including circular arc, parabolic arc, hyperbolic arc, elliptical arc.

As used herein, the term “non null angle” is used to describe an angle that is greater than zero degrees and less than 90 degrees. The angle (θ) is determined using the cross-sectional profile of the cut edge. The cross-sectional profile can be determined using an optical profile as generated by 2D Non-Contact Surface Metrology. One suitable piece of equipment is the MicroSpy® Profile (commercially available from Fries Research & Technology GmbH, Bergisch Gladbach, Germany). The angle formed by the cut edge with a direction perpendicular to the plane (O) of the blank is measured at five different locations over the length of one cut edge. Then, the arithmetic mean of the five measured values is calculated to obtain the angle (θ). For example, if the length of the ablated line is 80 millimetres, the residual thickness is measured at both ends of the ablated line and at three further points at a distance of 20 millimetres, 40 millimetres and 60 millimetres, respectively, from one end of the ablated line, preferably from the lower end of the cut edge.

Containers according to the present invention are at least partially formed from a blank having a predetermined thickness, an inner surface and an outer surface. At least a portion of the blank is delimited by a plurality of cut edges, wherein the blank portion has a first surface and a second surface. At least one of the cut edges in the plurality of cut edges has a cut edge surface that lies in a plane (A) forming a non null angle (θ) with a plane (O) orthogonal to the first surface and the second surface of the blank portion. The first and the second plane (A, O) belong to a same sheaf of planes. The axis of the sheaf of planes extends along the plane defined by the first surface of the blank. Thus, at the at least one cut edge, the second surface of the blank portion extends beyond the periphery of the first surface of the blank portion. Without wishing to be bound to theory, it may be appreciated that, in containers and blanks in accordance with the present invention, the second surface of the blank portion will extend beyond the periphery of the first surface by a length that is approximately (tag θ) times the thickness (T) of the blank.

In a first embodiment, the first surface of the blank portion is the inner surface of the blank portion and the second surface of the blank portion is the outer surface of the blank portion. Containers according to the first embodiment of the present invention have the advantage that, because the outer surface of the blank portion extends beyond the periphery of the outer surface of the blank portion, the surface of the cut edge is less easily visible for the consumer. This is desirable because, in general, the surface of the cut edge may be visually perceived as a local discontinuity in the coating, colouring or pattern of the outer surface of the blank portion. By contrast, containers according to the first embodiment of the present invention are generally perceived as having a better finish and an improved look.

It should further be noted that, when a laser beam is used as a cutting tool, the blank may at times become locally stained or discoloured due to the interaction of the blank material with the laser beam. This is undesirable because, after the blank is folded to form a container, an edge surface burnt by the laser beam may become visible to the consumer. Containers in accordance with the first embodiment of the present invention have the advantage that, if the laser beam causes some local deterioration of the blank material on the cut edge surface, for example by “burning”, staining or discolouring the blank material, this is not visible from the outside, and the consumer is desirably presented with a blank surface that is substantially undamaged and unaltered.

In a second embodiment, the first surface of the blank portion is the outer surface of the blank portion and the second surface of the blank portion is the inner surface of the blank portion. Containers in accordance with the second embodiment of the present invention have the advantage that at least one of the cut edges of the container has an increased surface area that is exposed to the consumer's gaze. This provides the container with a novel look that may have a distinctive visual impact on the consumer. By selecting which cut edges of a container are formed in accordance with the invention, it is easy to adjust and modify the look of the container.

Preferably, the angle (θ) is at least about 10 degrees. With smaller angles, aesthetic flaws caused by the interaction of the laser beam with the blank material are still too easy to detect for the consumer. More preferably, the angle (θ) is at least about 20 degrees. Even more preferably, the angle (θ) is at least about 30 degrees.

In addition, or as an alternative, the angle (θ) is preferably less than about 60 degrees. Larger angles are particularly disadvantageous in containers according to the first embodiment of the invention, because this may potentially reveal underlying aesthetic flaws caused by the interaction of the laser beam with the blank material. More preferably, the angle (θ) is less than about 50 degrees. Even more preferably, the angle (θ) is less than about 45 degrees. In some preferred embodiments, the angle (θA) is from about 10 degrees to about 60 degrees, more preferably from about 30 degrees to 45 degrees.

In some embodiments, the at least one cut edge defines a segment of the periphery of a wall of the container. In other embodiments, the at least one cut edge defines a segment of a cut out portion in a wall of the container. In general, the present invention may be applied to all the peripheral edges of a blank. Where a blank has one or more cut out portions, the invention may be applied to all the edges of a cut out portion. The cut edge formed in accordance with the present invention may extend along a straight line, a curved line or a combination thereof.

Containers according to the present invention find application as containers for consumer goods, in particular elongate consumer goods such as smoking articles. However, they can also be used for several other types of consumer goods.

The blank may be formed from any suitable material or combination of materials, including, but not limited to, cardboard, paperboard, plastic, metal, or combinations thereof. Preferably, the blank is a laminar blank. Even more preferably, the blank is a cellulose-fibre-based laminar blank. “Cellulose-fibre-based” means comprising at least 50 weight-percent cellulose, preferably wood cellulose, fibres based on the total fibre content of the laminar blank. A cellulose-fibre-based laminar blank according to the invention may include other types of fibres, for example polymer fibres.

Preferably, the blank has a basis weight of from about 100 grams per square metre and about 350 grams per square metre. In some preferred embodiments, the blank has a basis weight of from about 150 grams per square metre to about 300 grams per square metre. It is understood that these ranges represent average values, and that the basis weight of the laminar blank may vary between several batches, that is plus ten percent or minus ten percent, preferably plus 5 percent or minus five percent.

Preferably, the thickness (T) of the blank is at least about 200 micrometres, more preferably at least about 250 micrometres and even more preferably at least about 300 micrometres. The thickness (T) of the laminar blank can be measured in accordance with ISO 534:2011.

The container may optionally comprise an outer wrapper, which is preferably a transparent polymeric film of, for example, high or low density polyethylene, polypropylene, oriented polypropylene, polyvinylidene chloride, cellulose film, or combinations thereof and the outer wrapper is applied in a conventional manner. The outer wrapper may include a tear tape. In addition, the outer wrapper may be printed with images, consumer information or other data.

Further, the consumer articles may be provided within the container in the form of a bundle wrapped in an inner package formed of metal foil or metallised paper. The inner package material may be formed as a laminate of a metallised polyethylene film, and a liner material. The liner material may be a super-calendered glassine paper. In addition, the inner package material may be provided with a print-receptive top coating. The inner package has an access opening through which consumer goods can be removed when a lid of the container is in a respective open position.

The container is preferably a rectangular parallelepiped comprising two wider walls spaced apart by two narrower walls. Hinge lid containers according to the invention may be in the shape of a rectangular parallelepiped, with right-angled longitudinal and right-angled transverse edges. Alternatively, the hinge lid container may comprise one or more rounded longitudinal edges, rounded transverse edges, bevelled longitudinal edges or bevelled transverse edges, or combinations thereof. For example, the hinge lid container according to the invention may comprise, without limitation:
One or two longitudinal rounded edges on the front wall, and/or one or two longitudinal rounded or bevelled edges on the back wall.
One or two transverse rounded edges on the front wall, and/or one or two transverse rounded or bevelled edges on the back wall.
One longitudinal rounded edge and one longitudinal bevelled edge on the front wall, and/or one transverse rounded edge and one transverse bevelled edge on the back wall.
One or two transverse rounded or bevelled edges on the front wall and one or two longitudinal rounded or bevelled edges on the front wall.
Two longitudinal rounded or bevelled edges on a first side wall or two transverse rounded or bevelled edges on the second side wall. Where the container comprises one or more bevelled edge, preferably the bevelled edge has a width of between about 1 mm and about 10 mm, preferably between about 2 mm and about 6 mm. Alternatively, the container may comprise a multi-bevelled edge formed by parallel creasing or scoring lines that are spaced such that two or more distinct bevels are formed on at least one edge of the container.

Alternatively, the container may have a non-rectangular transversal cross section, for example polygonal such as triangular or hexagonal, semi-oval or semi-circular.

Containers according to the invention find particular application as packs for elongate smoking articles such as, for example, cigarettes, cigars or cigarillos. It will be appreciated that through appropriate choices of the dimensions thereof, containers according to the invention may be designed for different numbers of conventional size, king size, super-king size, slim or super-slim cigarettes. Alternatively, other consumer goods may be housed inside the container.

Through an appropriate choice of the dimensions, containers according to the invention may be designed to hold different total numbers of smoking articles, or different arrangements of smoking articles. For example, through an appropriate choice of the dimensions, containers according to the invention may be designed to hold a total of between ten and thirty smoking articles.

The smoking articles may be arranged in different collations, depending on the total number of smoking articles.

Containers according to the present invention may hold smoking articles of the same type or brand, or of different types or brands. In addition, both filter-less smoking articles and smoking articles with various filter tips may be contained, as well as smoking articles of differing length (for example, between about 40 mm and about 180 mm), diameter (for example, between about 4 mm and about 9 mm). Preferably, the dimensions of the container are adapted to the length of the smoking articles, and the collation of the smoking articles. Typically, the outer dimensions of the container are between about 0.5 mm to about 5 mm larger than the dimensions of the bundle or bundles of smoking articles housed inside the container.

The length, width and depth of containers according to the invention may be such that the resultant overall dimensions of the container are similar to the dimensions of a typical disposable pack of twenty cigarettes.

Preferably, containers according to the invention have a height of between about 60 mm and about 150 mm, more preferably a height of between about 70 mm and about 125 mm, wherein the height is measured from the bottom wall to the top wall of the container.

Preferably, containers according to the invention have a width of between about 12 mm and about 150 mm, more preferably a width of between about 70 mm and about 125 mm, wherein the width is measured from one side wall to the other side wall of the container.

Preferably, containers according to the invention have a depth of between about 6 mm and about 150 mm, more preferably a depth of between about 12 mm and about 25 mm wherein the depth is measured from the front wall to the back wall of the container.

Preferably, the ratio of the height of the container to the depth of the container is in between about 0.3 to 1 and about 10 to 1, more preferably between about 2 to 1 and about 8 to 1, most preferably between about 3 to 1 and 5 to 1

Preferably, the ratio of the width of the container to the depth of the container is in between about 0.3 to 1 and about 10 to 1, more preferably between about 2 to 1 and about 8 to 1, most preferably between about 2 to 1 and 3 to 1.

Preferably, the ratio of the height of the lid back wall to the height of the box back wall of the outer sleeve is between about 0 to 1 (lid located at the top edge of the container) to about 1 to 1, more preferably, between about 1 to 5 and about 1 to 10, most preferably, between about 1 to 6 to about 1 to 8.

Preferably, the ratio of the height of the lid front wall of the outer sleeve to the height of the box front wall of the outer sleeve is between about 1 to 0 (lid covering the entire front wall) to about 1 to 10, more preferably, between about 1 to 1 and about 1 to 5, most preferably, between about 1 to 2 and about 1 to 3.

The exterior surfaces of containers according to the invention may be printed, embossed, debossed or otherwise embellished with manufacturer or brand logos, trade marks, slogans and other consumer information and indicia.

Containers according to the invention may be filled and assembled using conventional apparatus modified to perform the cutting operation by cutting through the blank with a laser beam directed against the inner surface of the blank along a direction (D) forming a non null angle (θ) with a direction (O) orthogonal to the inner surface and the outer surface of the blank portion, such that at the cut edge the outer surface of the blank portion extends beyond the periphery of the inner surface of the blank portion.

A laser is particularly preferred as the cutting tool as it can allow for a wide variety of cutting profiles and configurations, with minimal adjustment of the laser tool being needed. In general, it is possible to accurately control the relative movement of the laser and the blank so as to form cut out portions of substantially any type of shape. Laser cutting may be performed using any suitable equipment, preferably a 1000 Watt carbon dioxide laser as commercially available from DIAMOND, for example the E-1000.

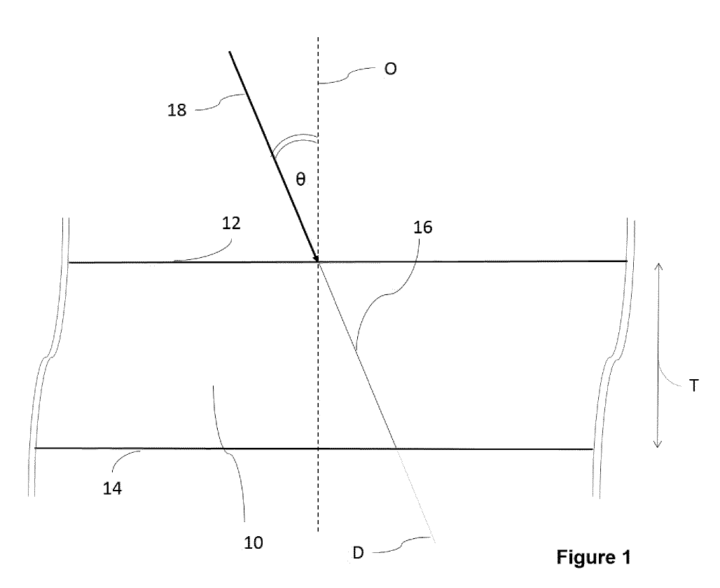

The invention will be further described, by way of example only, with reference to the accompanying FIG. 1, which depicts a schematic cross-sectional view of an edge portion of a blank in accordance with the present invention.

FIG. 1 illustrates a cutting operation in the manufacturing of a blank 10 for forming a container for consumer articles in accordance with the present invention. The blank 10 is formed from a laminar cardboard with a weight of between about 100 grams per square metre and about 350 grams per square metre and a thickness T of 200 micrometres. The blank 10 has an inner surface 12 and an outer surface 14.

A cut edge 16 of a portion of the blank 10 is formed by cutting through the laminar board with a laser beam 18 directed against the inner surface 12 of the blank 10 along a direction D forming an angle θ of about 30 degrees with a direction O orthogonal to the inner surface 12 and the outer surface 14 of the portion of the blank 10. Thus, at the cut edge 16 the outer surface 14 of the blank portion extends beyond the periphery of the inner surface 12 of the blank portion. By way of example, the cut edge 16 may become arranged at a peripheral edge of the assembled container, or it may at least partly delimit a cut out in a wall of the assembled container.

When a container is assembled from the blank 10, the blank is folded into the desired shape with the surface of the cut edge 16 arranged such as to face at least partially away from the consumer's gaze. Because the outer surface 14, which extends beyond the periphery of the inner surface 12, is directly exposed to the consumer, any local defect potentially caused by the laser on the surface of the cut edge 16, such as the partial deterioration of the blank material, is not visible from the outside. In practice, the surface of the cut edge 16 is hidden from sight by the outer surface 14. Accordingly, the consumer is advantageously presented with a blank surface that is substantially undamaged and unaltered.

1. A container for consumer articles, the container being formed from a cellulose-fibre-based laminar blank by folding the blank into the desired shape, the blank having a thickness (T), a first surface and a second surface,
wherein at least a planar portion of the blank is delimited by a plurality of cut edges that extend from the first surface of the blank to the second surface of the blank;
wherein at least one of the cut edges defines a segment of the periphery of a blank panel for forming a wall of the container or a segment of a cut out portion in a wall of the assembled container, the at least one cut edge being formed by cutting the blank with a laser beam and having a partially exposed cut edge surface that extends between the first surface and the second surface along a first plane (A) forming a non null angle (θ) with a second plane (O) that is orthogonal to the first surface and the second surface of the blank portion, the first and the second plane (A, O) belonging to a same sheaf of planes, wherein the axis of the sheaf of planes extends along the plane defined by the first surface of the blank,
such that, at the at least one cut edge, the second surface of the blank portion extends beyond the periphery of the first surface of the blank portion.

2. A container according to claim 1, wherein the first surface of the blank portion is the inner surface of the blank portion and the second surface of the blank portion is the outer surface of the blank portion.

3. A container according to claim 1, wherein the first surface of the blank portion is the outer surface of the blank portion and the second surface of the blank portion is the inner surface of the blank portion.

4. A container according to claim 1, wherein the angle (θ) is at least about 10 degrees.

5. A container according to claim 1, wherein the angle (θ) is less than about 60 degrees.

6. A container according to claim 1, wherein the at least one cut edge defines a segment of the periphery of a wall of the container.

7. A container according to claim 1, wherein the at least one cut edge defines a segment of a cut out portion in a wall of the container.

8. A container according to claim 1, wherein the at least one cut edge extends along a straight line, a curved line or a combination thereof.

9. A container according to claim 1, wherein the thickness (T) of the blank is at least about 200 micrometres.

10. A container according to claim 1, containing a plurality of smoking articles.

11. A blank for forming a container for consumer articles by folding the blank into the desired shape, the blank being formed from cardboard or paperboard and having a thickness (T) and at least a planar portion of the blank delimited by a plurality of cut edges, wherein the blank portion has a first surface and a second surface;
wherein at least one of the cut edges in the plurality of cut edges defines a segment of the periphery of a blank panel for forming a wall of the container or a segment of a cut out portion in a blank panel for forming a wall of the container, is formed by cutting the blank with a laser beam, and has a cut edge surface that lies in a plane (A) forming a non null angle (θ) with a plane (O) that is orthogonal to the first surface and the second surface of the blank portion, the first and the second plane (A, O) belonging to a same sheaf of planes, wherein the axis of the sheaf of planes extends along the plane defined by the first surface of the blank, such that, at the at least one cut edge, the second surface of the blank portion extends beyond the periphery of the first surface of the blank portion.

12. (canceled)

13. (canceled)

14. (canceled)

15. A blank according to claim 11, wherein the angle (θ) is from about 10 degrees to about 60 degrees.
